(19) United States
(12) Patent Application Publication
(10) Pub. No.: US 2022/0188952 A1
(43) Pub. Date: Jun. 16, 2022

(54) INFORMATION PROCESSING APPARATUS, INFORMATION PROCESSING METHOD, NON-TRANSITORY MEMORY MEDIUM, AND INFORMATION PROCESSING SYSTEM

(71) Applicant: TOYOTA JIDOSHA KABUSHIKI KAISHA, Toyota-shi (JP)

(72) Inventors: Toyokazu Nakashima, Nagoya-shi (JP); Makoto Tamura, Miyoshi-shi (JP); Yusuke Mitoma, Nisshin-shi (JP); Kosuke Kotake, Nagoya-shi (JP); Junko Katoh, Nagoya-shi (JP); Noriko Koreyasu, Toyota-shi (JP); Hiromi Tonegawa, Konan-shi (JP); Aiko Fujii, Nagoya-shi (JP); Yuutarou Miyashita, Nagoya-shi (JP)

(73) Assignee: TOYOTA JIDOSHA KABUSHIKI KAISHA, Toyota-shi (JP)

(21) Appl. No.: 17/457,515

(22) Filed: Dec. 3, 2021

(30) Foreign Application Priority Data
Dec. 15, 2020 (JP) 2020-207897

(51) Int. Cl. G06Q 50/26; G08G 1/00

(52) U.S. Cl. CPC G06Q 50/265; G05D 1/021; G08G 1/202

(57) ABSTRACT

An information processing apparatus of the present disclosure includes a controller including at least one processor configured to execute acquiring location information and a current status for each of a plurality of cooperators capable of performing rescue of a person to be rescued, and transmitting, a rescue request to a cooperator who is located within a predetermined range from the person to be rescued and is in a predetermined status, among the plurality of cooperators, as a target cooperator when a person to be rescued is present.

### CROSS-REFERENCE TO THE RELATED APPLICATION

This application claims priority to Japanese Patent Application No. 2020-207897, filed on Dec. 15, 2020, which is hereby incorporated by reference in its entirety.

### BACKGROUND

### Technical Field

The present disclosure relates to an apparatus that supports a lifesaving procedure.

### Description of the Related Art

There is a system that determines a lifesaving necessity based on a result of sensing biological information. For example, Japanese Patent Laid-Open No. 2012-222443 discloses a system that determines the urgency of critical care based on the biological information acquired from a user, and transmits a rescue request to any of a plurality of cooperators registered in advance, based on a distance from a person to be rescued.

[Patent document 1] Japanese Patent Laid-Open No. 2012-222443.

### SUMMARY

In the existing system, a rescue request can be transmitted to cooperators nearest to a person to be rescued. However, the registered cooperators are not always in a situation capable of responding to the request.

One or more aspects of the present disclosure are directed to provide a system for quickly rescuing a person to be rescued.

An information processing apparatus according to a first aspect of the present disclosure may comprise a controller including at least one processor configured to execute acquiring location information and a current status for each of a plurality of cooperators capable of performing rescue of a person to be rescued, and transmitting a rescue request to a cooperator who is located within a predetermined range from the person to be rescued and is in a predetermined status, among the plurality of cooperators, as a target cooperator, when a person to be rescued is present.

An information processing method according to a second aspect of the present disclosure may comprise acquiring location information and a current status for each of a plurality of cooperators capable of performing rescue of a person to be rescued, and transmitting a rescue request to a cooperator who is located within a predetermined range from the person to be rescued and is in a predetermined status, among the plurality of cooperators, as a target cooperator, when a person to be rescued is present.

An information processing system according to a third aspect of the present disclosure may comprise a plurality of mobile terminals that is respectively held by a plurality of cooperators capable of performing rescue of a person to be rescued, and an information processing apparatus capable of communicating with the mobile terminals, in which the mobile terminal comprises a first controller including at least one processor configured to transmit, to the information processing apparatus, first data including at least location information, the first data relating to a current status of each cooperator, and the information processing apparatus comprises a second controller including at least one processor configured to execute receiving the first data from the mobile terminals, acquiring the location information and the current status for each of the plurality of cooperators, based on the first data, and transmitting a rescue request to a cooperator who is located within a predetermined range from the person to be rescued and is in a predetermined status, among the plurality of cooperators, as a target cooperator, when a person to be rescued is present.

Another aspect may provide a computer-readable memory medium storing a program in a non-transitory manner, the program causing a computer to implement the information processing method.

The present disclosure can provide a system for quickly rescuing a person to be rescued.

### BRIEF DESCRIPTION OF THE DRAWINGS

FIG. 1 is a schematic diagram of an emergency notification system according to a first embodiment;

FIG. 2 is a block diagram schematically illustrating an example of a server device;

FIG. 3 is a diagram illustrating an example of user data stored in the server device;

FIG. 4 is a diagram illustrating an example of behavioral pattern data stored in the server device;

FIG. 5 is a block diagram schematically illustrating an example of a mobile terminal;

FIG. 6 is a flowchart of data received and transmitted between components;

FIG. 7 is a flowchart of data received and transmitted between components;

FIG. 8 is a flowchart illustrating processes in step S16 in the first embodiment;

FIG. 9 is a diagram illustrating data used in a modified example of the first embodiment;

FIG. 10 is a flowchart illustrating processes in step S16 in a second embodiment;

FIG. 11 is a schematic diagram of an emergency notification system according to a third embodiment; and

FIG. 12 is a flowchart illustrating processes in step S16 in the third embodiment.

### DETAILED DESCRIPTION

An aspect of the present disclosure may provide an information processing apparatus that determines the presence of a person to be rescued and transmits a rescue request to a plurality of cooperators registered in advance.

Specifically, the information processing apparatus may include a controller that executes acquiring location information and a current status for each of a plurality of cooperators capable of performing the rescue of a person to be rescued, and transmitting a rescue request to a cooperator who is located within a predetermined range from the person to be rescued and is in a predetermined status, among the plurality of cooperators, as a target cooperator, when a person to be rescued is present.

The person to be rescued may be typically a person who needs prompt treatment for injury, disease, or the like. The presence of the person to be rescued can be determined based on a result of sensing the biological information or by an existing sensor (a sensor that detects tumbling, a sensor that detects a movement, or the like), for example.

The person to be rescued need not necessarily be a life-threatening person. For example, the person to be rescued may be a lost child or elderly person, a handicapped person needing help, or the like.

The information processing apparatus may determine a person to which the rescue request is to be transmitted, among the plurality of cooperators registered in advance, when a person to be rescued is present. Specifically, the cooperator who is located within a predetermined distance from the person to be rescued and is in the predetermined status may be determined as a target cooperator to whom the rescue request is to be transmitted.

The cooperator may be a user registered in advance as a person capable of responding to the rescue request. The cooperator may be a healthcare professional such as a doctor or a nurse, or may be a general user having taken lifesaving training, or the like. Alternatively, the cooperator may be a manager for an automated external defibrillator (AED).

The status is information as to whether the cooperator can respond to the request. The status may be, for example, a type of behavior or task being currently performed by the cooperator (while commuting, while working, while driving, while moving, or the like). Only the person capable of responding to the rescue request can be extracted with reference to the status of the cooperator.

The controller may be configured to receive first data including at least the location information from a mobile terminal held by each of the plurality of cooperators, the first data relating to a current status of each cooperator, and estimate the status of each cooperator based on the first data.

The first data may include any data relating to the status of the cooperator in addition to the location information.

Additionally, the information processing apparatus may further include a storage that stores a typical behavioral pattern for each of the plurality of cooperators, and the controller may be configured to estimate the status of each cooperator by checking the location information included in the first data against the behavioral pattern.

The behavioral pattern may record a typical behavior of the cooperator in association with the location information, for example. The controller may estimate the status of the cooperator being at a certain location with reference to the behavioral pattern. The behavioral pattern may be data in which a geographic location, a status, and a time frame are associated with one another.

Additionally, the controller may be configured to further acquire current moving body for each of the plurality of cooperators, and estimate required time until the target cooperator arrives at a location of the person to be rescued, based on the moving body.

Determining how each cooperator is moving makes it possible to select the cooperator capable of arriving at the location of the person to be rescued more quickly.

The controller may be configured to determine the cooperator to whom the rescue request is to be transmitted, based on the estimated required time.

For example, the controller may be configured to transmit the rescue request preferentially to the cooperator who has a shorter estimated required time than other cooperators.

The moving body may be a vehicle, and the controller may be configured to acquire vehicle information from a vehicle associated with each of the plurality of cooperators, and determine whether the target cooperator is riding in the vehicle, based on the vehicle information.

For example, when a current location of a terminal associated with the cooperator coincides with a current location of a vehicle associated with the cooperator, the controller can determine that the cooperator is riding in the vehicle. The vehicle may be an automobile, or may be a bicycle, a motorcycle, a personal mobility, or the like.

When a cooperator is not using the vehicle for movement, the controller may be configured to calculate the required time in the case where the cooperator is caused to get on an autonomous traveling vehicle to go to the location of the person to be rescued.

Dispatching the autonomous traveling vehicle to the location of the cooperator enables the cooperator to quickly arrive at the location of the person to be rescued.

Therefore, the controller may be configured to acquire location information on a plurality of autonomous traveling vehicles and determine an allocable autonomous traveling vehicle based on the location information. The location information may be acquired from a device that manages operations of the autonomous traveling vehicles, for example.

Additionally, the information processing apparatus further includes a storage that stores data for each of the plurality of cooperators, in which the status of the cooperator is associated with whether the cooperator is capable of responding to the person to be rescued, and the controller may be configured to transmit the rescue request to the cooperator determined to be capable of responding to the rescue request based on the acquired status.

Whether a person is capable of responding to the person to be rescued for each status may vary from person to person. For example, in the case of a certain cooperator doing highly specialized work, it may be difficult to respond to the person to be rescued while working. Alternatively, in the case of another cooperator working at home, it may be possible to respond to the person to be rescued even while working. Therefore, a cooperator capable of responding to the person to be rescued can be identified with high accuracy by holding, for each status, the information indicating whether the cooperator is capable of responding to the person to be rescued.

Hereinafter, embodiments of the present disclosure will be described based on the drawings. The following configurations of the embodiments are illustrative, and the present disclosure is not limited to the configurations of the embodiments.

### First Embodiment

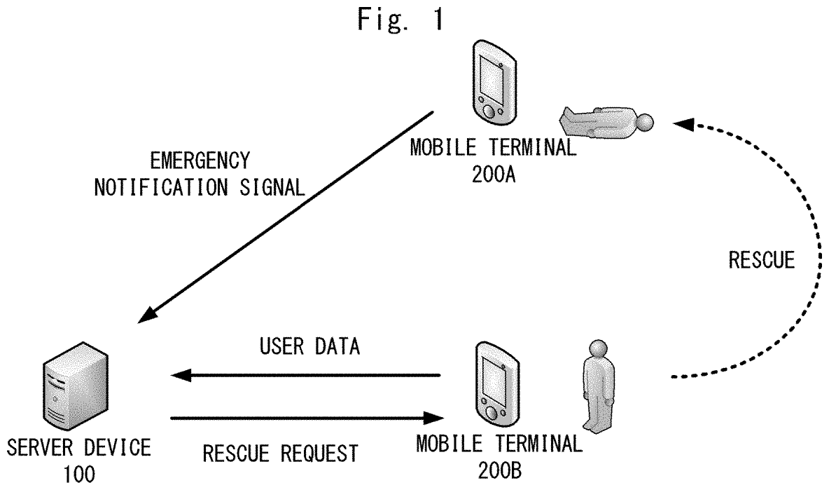

An overview of an emergency notification system according to a first embodiment will be described with reference to FIG. 1. The system according to the present embodiment includes a server device 100 and a plurality of mobile terminals 200.

In the following description, a person to be rescued refers to a person who needs prompt treatment for injury or disease. Additionally, a cooperator refers to a person registered in advance who is capable of treating (e.g., performance of first aid, performance of cardiopulmonary resuscitation, or the like) the person to be rescued.

The mobile terminal 200 performs the following two types of processes. A first process is a function of detecting that an abnormality has occurred in the body of a user (a person to be rescued) based on a result of sensing the user, and notifying the server device 100 of the fact.

A second process is a function of receiving, from the server device 100, information that the person to be rescued is present in the neighborhood, and notifying a user who is a cooperator of the fact.

In the following description, the mobile terminal 200 held by a person to be rescued is also referred to as a mobile terminal 200A (a person-to-be-rescued terminal), and the mobile terminal 200 held by a cooperator is also referred to as a mobile terminal 200B (a cooperator terminal). The mobile terminal 200 functions as either the person-to-be-rescued terminal or the cooperator terminal according to circumstances.

The server device 100 determines the presence of the person to be rescued, based on the information received from the mobile terminal 200A, and identifies a person capable of responding to the person to be rescued, among a plurality of cooperators registered in advance. Additionally, the server device 100 transmits, to the associated mobile terminal 200B, data requesting the rescue (hereinafter, referred to as a rescue request). In this way, the cooperator is capable of going to the location of the person to be rescued.

Components of the system will be described in detail.

The server device 100 may be constituted by a computer. Specifically, the server device 100 may be constituted as a computer including a processor such as a CPU or a GPU, a main memory such as a RAM or a ROM, and an auxiliary memory such as EPROM, a hard disk drive, or a removable medium. The auxiliary memory stores an operating system (OS), various programs, various tables, and the like, and each of the functions suitable for a predetermined purpose as will be described later may be implemented by executing a program stored in the auxiliary memory. However, some or all of the functions may be implemented by a hardware circuit such as ASIC or FPGA.

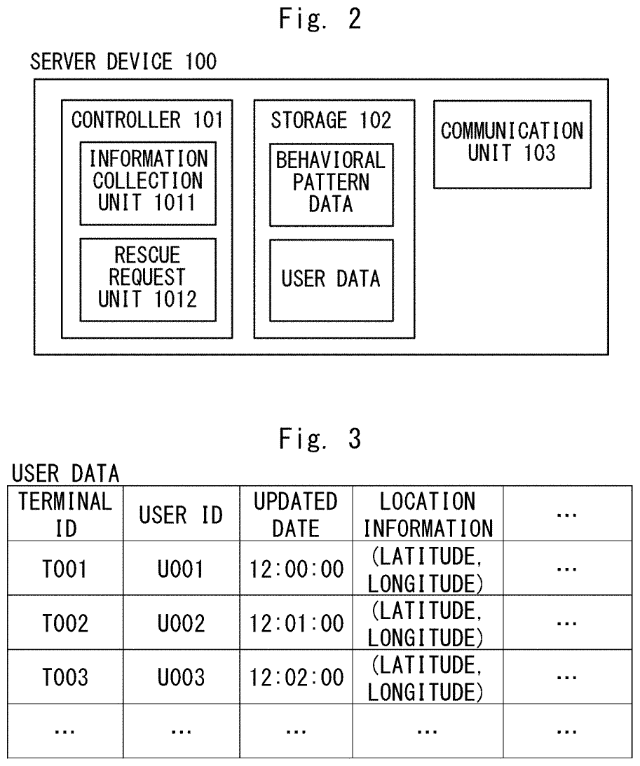

FIG. 2 is a block diagram schematically illustrating an example of a configuration of the server device 100 illustrated in FIG. 1. The server device 100 includes a controller 101, a storage 102, and a communication unit 103.

The controller 101 is a unit that controls the server device 100. The controller 101 is constituted by an arithmetic device such as a CPU.

The controller 101 includes an information collection unit 1011 and a rescue request unit 1012 as functional modules. Each functional module may be implemented by the CPU executing a program stored in storage such as the ROM.

The information collection unit 1011 collects the data from the mobile terminal 200. Specifically, the information collection unit 1011 periodically communicates with the plurality of mobile terminals 200 held by the plurality of cooperators registered with the system, and receives the data (user data) relating to the statuses for the cooperators to cause the storage 102, as will be described later, to store the received data. In the present embodiment, the status of a cooperator refers to behavior being performed by the cooperator. Additionally, in the present embodiment, the location information of the mobile terminal 200 is used as the user data.

When receiving an emergency notification signal from the mobile terminal 200A held by the person to be rescued, the rescue request unit 1012 extracts a cooperator capable of responding to the person to be rescued from among the plurality of cooperators, and transmits the rescue request to the mobile terminal 200B held by the extracted cooperator.

Specifically, the rescue request unit 1012 determines a current location and current behavior of each cooperator based on the collected user data and behavioral pattern data stored in the storage 102, as will be described later, and selects the cooperator capable of responding to the person to be rescued, based on the determination results.

The storage 102 stores information, and is constituted by a memory medium such as a RAM, a magnetic disk, or a flash memory. The storage 102 stores various programs to be executed by the controller 101, the data to be used by the program, and the like. The storage 102 stores the above-described user data and behavioral pattern data.

FIG. 3 illustrates an example of a table that stores user data. The user data includes an identifier of each mobile terminal 200, an identifier of each user (cooperator), the location information of each mobile terminal 200, and the like. The table is periodically updated based on the user data received from each mobile terminal 200 by the controller 101.

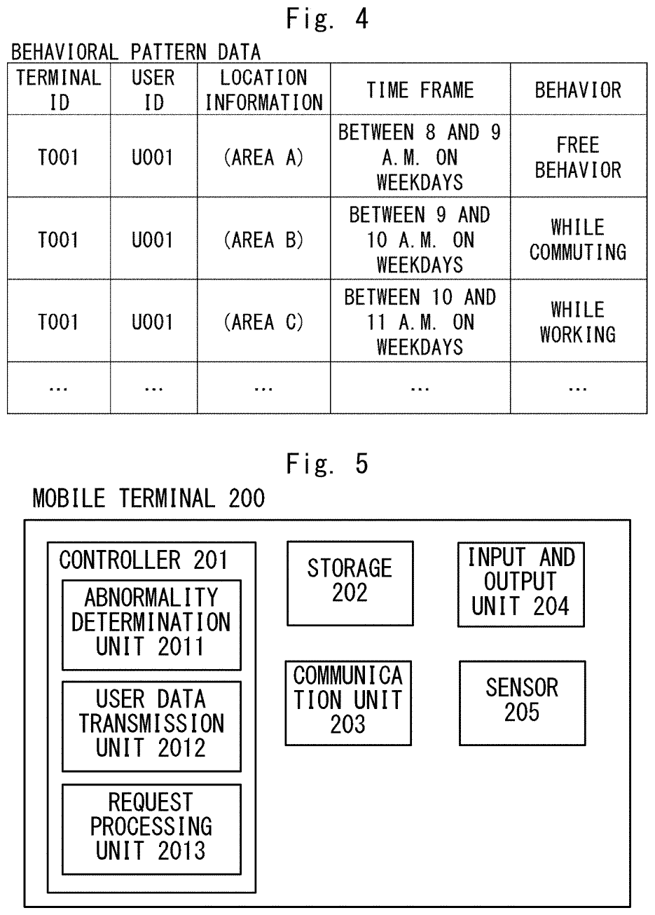

FIG. 4 illustrates an example of a table that stores behavioral pattern data. The behavioral pattern data is data in which the time frame, the location information and the behavior is associated with one another, for each of the plurality of cooperators. For example, the illustrated example indicates that when a cooperator with an identifier U001 is within an area B in a time frame between 9 and 10 a.m. on weekdays, the cooperator performs behavior called “commuting.” The behavior being performed by the target cooperator can be estimated by checking the acquired location information against the behavioral pattern data. The behavioral pattern data may be generated based on the data input beforehand by the cooperator or may be automatically generated by a machine learning model that classifies the behavior, or the likes.

The communication unit 103 is a communication unit that connects the server device 100 to the network. In the present embodiment, the communication unit 103 can communicate with other devices (e.g., the mobile terminals 200) through the network using a mobile communication service such as 4G or LTE.

Next, the mobile terminal 200 will be described. FIG. 5 is a block diagram schematically illustrating an example of a configuration of the mobile terminal 200.

The mobile terminal 200 is a small computer such as a smartphone, a cellular phone, a tablet terminal, a personal digital assistant, or a wearable computer (a smart watch, or the like), for example. The mobile terminal 200 includes a controller 201, a storage 202, a communication unit 203, an input and output unit 204, and a sensor 205.

The controller 201 controls the mobile terminals 200. The controller 201 is constituted by a microcomputer, for example. The controller 201 may implement these functions by the CPU executing a program stored in the storage 202, as will be described later.

The controller 201 includes an abnormality determination unit 2011, a user data transmission unit 2012, and a request processing unit 2013 as functional modules. Each functional module may be implemented by the CPU executing a program stored in a storage unit (a ROM or the like).

The abnormality determination unit 2011 determines that any abnormality has occurred in the user who is an owner of the terminal, based on the information obtained from the sensor 205 as will be described later. The abnormality can be determined by, for example, methods described below, but the method is not limited thereto.

(1) The abnormality determination unit 2011 determines that the user is tumbling or in another posture, based on output of an acceleration sensor, and determines that an accident has occurred when the user does not move thereafter.

(2) The abnormality determination unit 2011 determines that an abnormality has occurred in a physical condition of the user, when the output of the sensor acquiring the biological information (heart rate, blood pressure, oxygen saturation, or the like) of the user indicates an abnormal value.

(3) The abnormality determination unit 2011 determines that an abnormality has occurred in a physical condition of the user when the motion of the user is stopped in a place such as on a road where the user usually will not rest.

(4) The abnormality determination unit 2011 determines that the user is lost or wanders when the mobile terminal 200 enters a place where the user usually will not visit.

When determining that an abnormality has occurred in the user, the abnormality determination unit 2011 generates a signal (emergency notification signal) notifying of the fact, and transmits the signal to the server device 100. The emergency notification signal may include the location information of the mobile terminal 200 and the data obtained from the sensor.

Note that the abnormality determination unit 2011 may also generate the emergency notification signal based on a report from the user.

The user data transmission unit 2012 acquires the location information of its own terminal, and generates the user data including the acquired location information to periodically transmit it to the server device 100. The user data is used for selection of the cooperator by the server device 100.

When receiving the rescue request from the server device 100, the request processing unit 2013 presents the contents to the cooperator. Specifically, the request processing unit 2013 presents the current location of the person to be rescued, the contents of the abnormality that has occurred in the person to be rescued, and the like, and acquires a reply from the cooperator, via the input and output unit 204, as will be described later.

The storage 202 stores information, and is constituted by a memory medium such as a RAM, a magnetic disk, or a flash memory. The storage 202 stores an electronic key transmitted from the server device 100, and various programs to be executed by the controller 201, the data, and the like.

The communication unit 203 is an interface that communicates with the server device 100 through the network.

The input and output unit 204 receives an input operation performed by the user and presents the information to the user. Specifically, the input and output unit 204 includes a touch panel and a control unit thereof, and a liquid crystal display and a control unit thereof. In the present embodiment, the touch panel and the liquid crystal display are constituted by a single touch panel display.

The sensor 205 includes one or more sensors that perform sensing of the user. The sensor may be a sensor that performs sensing of the biological information of the user, or may be a sensor that performs sensing of movement of the mobile terminal 200, an impact applied to the mobile terminal 200, or the like. The sensor may be a sensor that acquires the location information based on the radio waves received from an artificial satellite. Alternatively, the sensor may be a combination thereof.

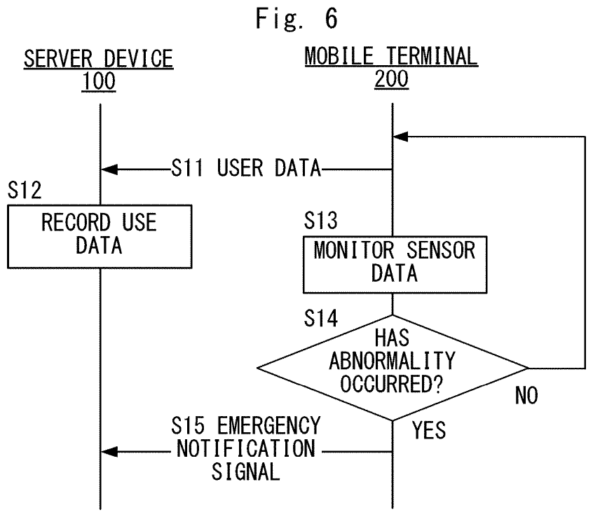

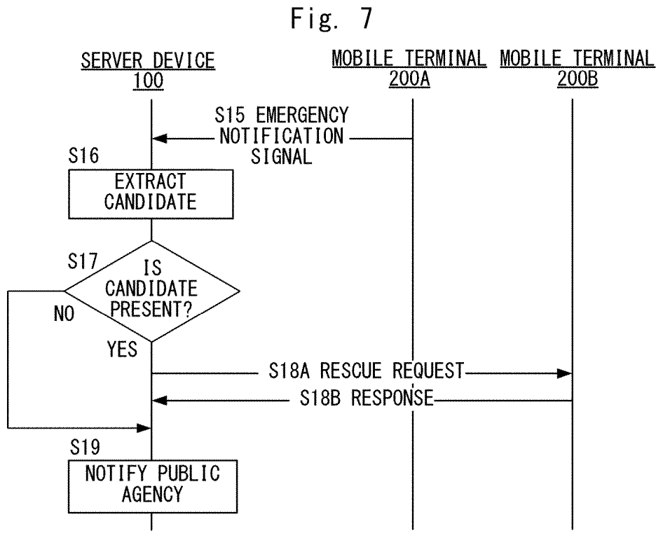

FIGS. 6 and 7 each are a diagram illustrating a flow of data received and transmitted between the server device 100 and the mobile terminal 200.

FIG. 6 is a chart illustrating a process in which the server device 100 periodically collects the user data from the mobile terminal 200, and a process in which the mobile terminal 200 transmits the emergency notification signal to the server device 100. The processes illustrated in FIG. 6 are periodically performed.

First, in step S11, the mobile terminal 200 (the user data transmission unit 2012) collects information about the behavior of the user, and transmits, to the server device 100 (the information collection unit 1011), the collected information as the user data. In the present embodiment, the mobile terminal 200 transmits the location information of the terminal as the information about the behavior of the user. The server device 100 causes the storage 102 to store the received user data (step S12).

In step S13, the mobile terminal 200 (the abnormality determination unit 2011) monitors sensor data acquired from the sensor 205. In step S14, the mobile terminal 200 determines whether the abnormality has occurred. Whether the abnormality has occurred can be determined based on acceleration data output by the acceleration sensor, heart rate data output by a heartbeat sensor, or data output by other sensors such as a sensor acquiring the biological information and a sensor detecting person's movements, for example. When it is determined that the abnormality has occurred (Yes in step S14), the process proceeds to step S15, and the emergency notification signal is transmitted to the server device 100. The emergency notification signal may include the sensor data, the contents of the abnormality determined by the abnormality determination unit 2011, or the location information and the like of the mobile terminal 200. When, in step S14, it is not determined that the abnormality has occurred (No in step S14), the process returns to an initial state.

Note that a grace period may be provided before the emergency notification signal is transmitted. For example, the mobile terminal 200 may be configured to transmit the emergency notification signal when no response returns with a predetermined time period after the mobile terminal 200 emits an alarm sound.

FIG. 7 is a chart illustrating processes after the emergency notification signal is transmitted from the mobile terminal 200 to the server device 100. Here, the terminal that transmits the emergency notification signal (i.e., the person-to-be-rescued terminal) is referred to as the mobile terminal 200A, and the cooperator terminal is referred to as the mobile terminal 200B.

When the information collection unit 1011 receives the emergency notification signal in step S15, the rescue request unit 1012 extracts a person (hereinafter, referred to as a “candidate”) requested to respond to the person to be rescued from among the plurality of cooperators registered in advance.

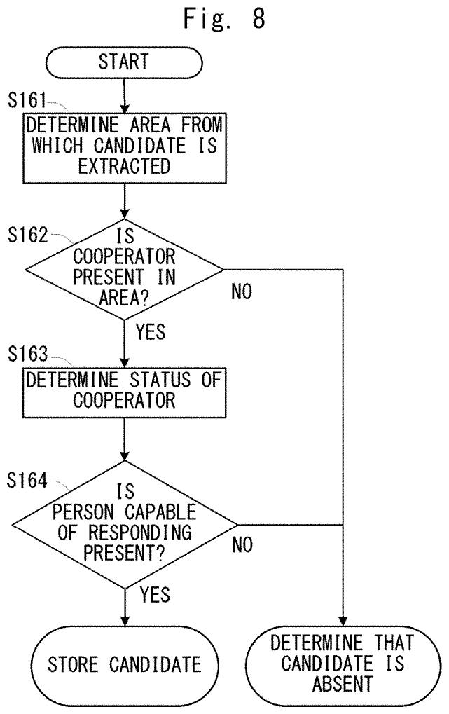

FIG. 8 is a flowchart illustrating processes in step S16 in detail. The processes illustrated in the figure are performed by the rescue request unit 1012.

In step S161, a predetermined range (e.g., within one kilometer) centered about the current location of the person to be rescued (i.e., the location indicated by the emergency notification signal) is determined as a target area from which the candidate is extracted.

In step S162, it is determined whether a cooperator is present in the determined area. Such determination can be made based on the user data acquired within a predetermined time period (e.g., within the last 5 minutes), for example.

In step S163, it is determined whether the cooperator is capable of responding to the person to be rescued, based on the behavior of the cooperator determined in step S162. Whether the cooperator is capable of responding to the person to be rescued can be determined based on the user data transmitted from the mobile terminal 200B.

For example, when the “behavior” indicated in the user data matches predetermined behavior, it can be determined that the cooperator is capable of responding to the person to be rescued. For example, when the current behavior is “free behavior,” it may be determined that the cooperator is capable of responding to the person to be rescued.

In step S164, the presence of a cooperator capable of responding to the person to be rescued is determined based on the determined behavior. Here, when the cooperator capable of responding to the person to be rescued is present, the cooperator is stored as a candidate. The number of candidates may be two or more. When the cooperator capable of responding to the person to be rescued is absent, a candidate is determined to be absent.

Returning to FIG. 7, the description will be continued.

As a result of the process in step S16, when it is determined that the candidate is present (Yes in step S17), the rescue request unit 1012 transmits the rescue request to the mobile terminal 200B held by the cooperator (step S18A). The rescue request includes the location information of the mobile terminal 200A. Additionally, the rescue request may include the contents of the abnormality determined by the mobile terminal 200A, and other information for identifying the person to be rescued.

The rescue request is received by the mobile terminal 200B (the request processing unit 2013), and the request processing unit 2013 presents the contents to the cooperator. Specifically, the request processing unit 2013 presents the current location of the person to be rescued, the data obtained from the sensor, and the like, and acquires the reply from the cooperator. The reply is transmitted to the server device 100 in step S18B.

When no response returns from the mobile terminal 200B, the server device 100 (the rescue request unit 1012) may transmit the rescue request to another candidate with a lower priority (who is located at a farther location, for example).

Finally, the server device 100 (the rescue request unit 1012) notifies a public agency (e.g., fire-fighting organization) of the presence of the person to be rescued (step S19). When a candidate is determined to be absent in step S16 (No in step S17), the process also proceeds to step S19.

As described above, the emergency notification system according to the first embodiment transmits a rescue request to a cooperator who is located in the vicinity of the person to be rescued, when a person to be rescued is present. This enables an initial response to the person to be rescued. Additionally, with reference to the current behavior of the cooperator, the rescue request can be transmitted to the cooperator with a higher possibility of being capable of responding to the person to be rescued.

### Modified Example of First Embodiment

In the first embodiment, the cooperator who is performing the predetermined behavior is extracted as a candidate. However, even when persons are performing the same behavior, the determination as to whether the person is capable of responding to the person to be rescued varies from person to person. For example, cooperators being “working” as the same behavior may include some cooperators capable of responding to the person to be rescued and some cooperators having a difficulty in responding to the person to be rescued.

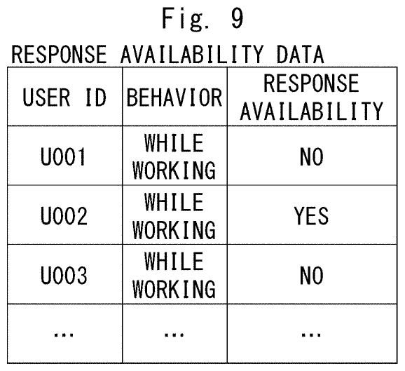

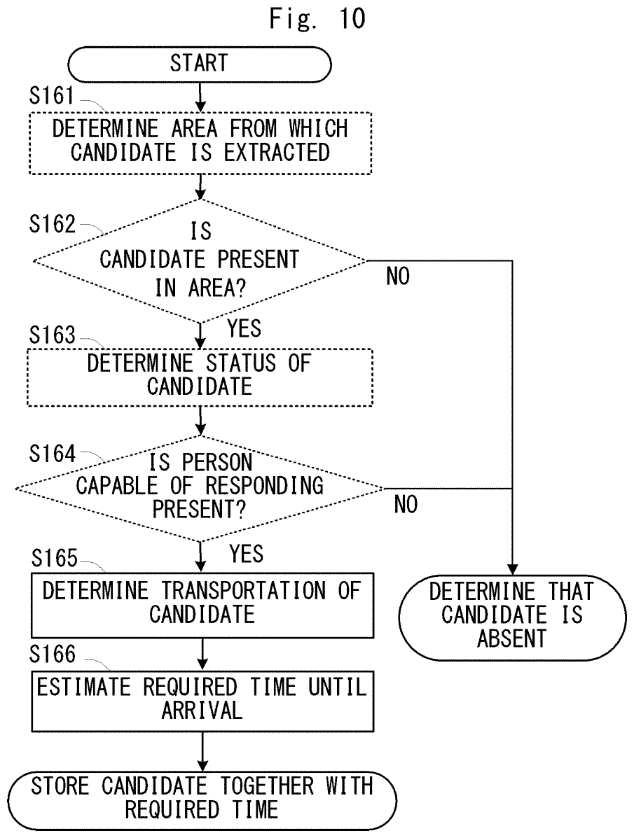

To solve the above-described problem, there may be used the data for each cooperator, in which the behavior of the cooperator is associated with whether the cooperator is capable of responding to the person to be rescued. For example, when the data illustrated in FIG. 9 is stored in the server device 100, whether a cooperator being performing certain behavior is capable of responding to the person to be rescued can be determined with reference to the stored data. Such data can be generated based on a report from each cooperator. According to such a configuration, a candidate capable of responding to the person to be rescued can be selected with high accuracy.

In the first embodiment, the server device 100 estimates the behavior of each cooperator using the behavioral pattern data stored in advance. However, the behavior of each cooperator may be estimated using something other than the behavioral pattern data. For example, the behavior may be estimated using a machine learning model that has learnt the relationship between the location information and the behavior of the cooperator.

Moreover, in the first embodiment, the mobile terminal 200 transmits the location information of the terminal as information about the behavior of the user, but the information to be transmitted by the mobile terminal 200 is not limited to the location information.

For example, the mobile terminal 200 may estimate the current behavior of the owner of the terminal based on the acquired sensor data, and transmit, to the server device 100, the estimated contents as the user data.

Furthermore, in the first embodiment, the current behavior of the cooperator is used as the status of the cooperator, but the information other than the behavior may be used as the status. For example, the information as to whether the cooperator is capable of responding to the person to be rescued may be reported via the mobile terminal 200, so that the candidate can be selected using the result.

### Second Embodiment

In the first embodiment, the candidate is selected based on a distance between the person to be rescued and the cooperator.

On the other hand, a second embodiment is an embodiment in which moving body of the cooperator is determined to estimate required time until a target cooperator arrives at a location of the person to be rescued, so that the result can be used for selection of the candidate.

The cooperators may move by various moving bodies. For example, some cooperators may be moving by bicycle, or some cooperators may be moving on foot. Therefore, determining moving body of the cooperator makes it possible to select the cooperator capable of arriving at the location of the person to be rescued more quickly.

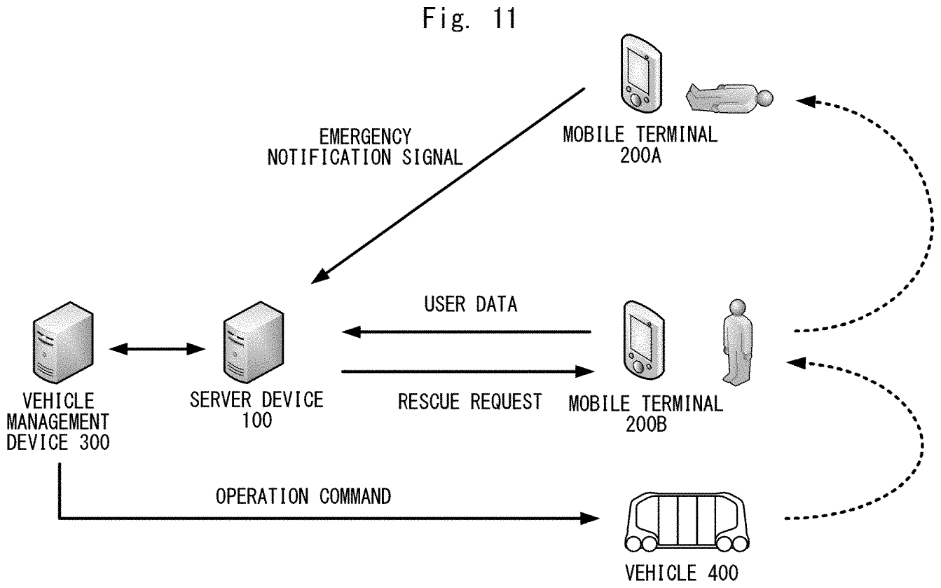

FIG. 10 is a flowchart illustrating processes to be performed by the server device 100 in step S16 in the present embodiment. In the present embodiment, after the process in step S164 is completed, the rescue request unit 1012 determines a transportation of each candidate. The transportation can be determined by, for example, methods described below.

(1) Moving Speed Transmitted from Mobile Terminal 200 or Moving Speed Calculated Based on Location Transition

For example, when the moving speed is equal to or less than five kilometers per hour, it is estimated that the target cooperator is moving on foot. When the maximum value of the moving speed is equal to or more than 80 kilometers per hour, it is estimated that the target cooperator is moving by train.

(2) Location Information Transmitted from Vehicle or the Like Associated with Cooperator

For example, the location information is acquired from a vehicle (or an on-board computer) by associating each of the plurality of cooperators with the vehicle (which is typically a private vehicle, but may be a bicycle or the like). When a place indicated by the location information transmitted from the mobile terminal 200 coincides with a place indicated by the vehicle, it can be estimated that the target cooperator is riding in the associated vehicle.

In step S166, the rescue request unit 1012 estimates required time until the target cooperator arrives at a location of the person to be rescued, based on the determined transportation. The required time can be estimated using the technology known in the art.

The estimated required time is stored together with the candidate, and is used in the following processes. For example, the rescue request may be transmitted preferentially to the cooperator who has a shorter estimated required time than other cooperators.

The second embodiment makes it possible to select the candidate capable of arriving at the location of the person to be rescued more quickly.

### Third Embodiment

A third embodiment is an embodiment in which an autonomous traveling vehicle is dispatched to the location of the cooperator who is moving on foot, to cause the cooperator to arrive at the location of the person to be rescued by the vehicle.

FIG. 11 is a schematic diagram of an emergency notification system according to a third embodiment.

An emergency notification system according to the third embodiment further includes a vehicle management device 300, and a plurality of vehicles 400. The vehicle 400 is an autonomous traveling vehicle functioning as an on-demand taxi. The vehicle management device 300 is a device that manages operations of a plurality of vehicles 400. The vehicle 400 is operated according to an operation command transmitted from the vehicle management device 300, so that a user can get on or off the vehicle 400.

In the present embodiment, the rescue request unit 1012 included in the server device 100 is configured to be capable of communicating with the vehicle management device 300. The rescue request unit 1012 determines whether to dispatch the vehicle 400 to the candidate, and, when determining that it is preferable to dispatch the vehicle 400, the rescue request unit 1012 requests the vehicle management device 300 to dispatch the vehicle 400.

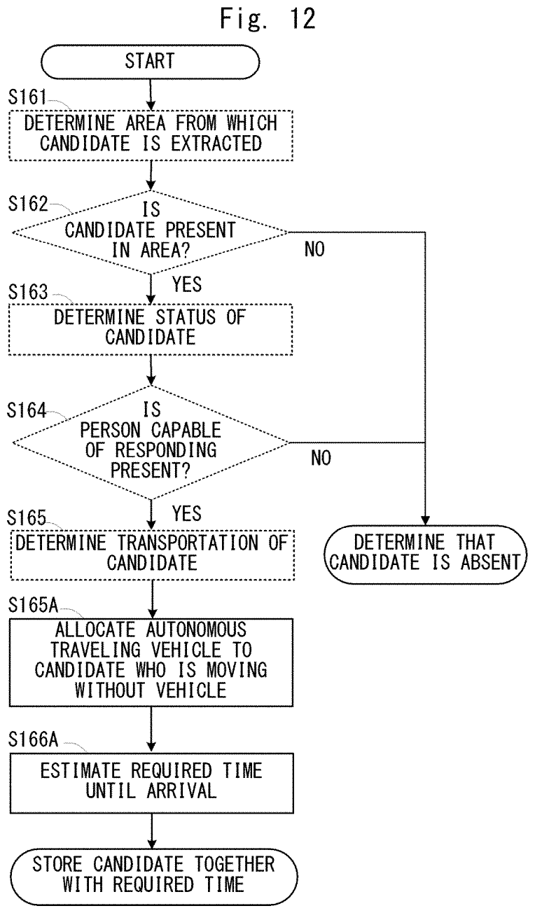

FIG. 12 is a flowchart illustrating processes to be performed by the server device 100 in the present embodiment. In the present embodiment, after the process in step S165 is performed, the vehicle 400 is allocated to the candidate who is moving without a vehicle (step S165A). The determination as to whether the vehicle 400 can be allocated, the location information of the allocable vehicle, and the like can be acquired from the vehicle management device 300.

In step S166A, the required time in the case where (1) the allocated vehicle 400 is caused to go to the location of the target candidate, (2) the target candidate is caused to get on the vehicle 400, and (3) the vehicle 400 is caused to go to the location of the person to be rescued are calculated. Each required time may be calculated by the server device 100 or may be acquired from the vehicle management device 300.

When the cooperator to whom the vehicle 400 is allocated responds to a rescue request and goes to the location of the person to be rescued, the server device 100 (the rescue request unit 1012) performs the process in step S19, and transmits, to the vehicle management device 300, the request to dispatch the allocated vehicle 400. The request includes the current location of the cooperator, the current location of the person to be rescued, and the like. The vehicle management device 300 generates a route of the vehicle 400 based on the request, and transmits, to the vehicle 400, the operation command to travel along the route.

As described above, the third embodiment enables the cooperator to be delivered quickly to the location of the person to be rescued.

As exemplified in this example, the server device 100 and the vehicle management device 300 are provided independently. However, the server device 100 may manage the plurality of vehicles 400. In this case, the server device 100 may be configured to receive detailed data about the operations from the vehicles 400, and determine the vehicle 400 to be dispatched, based on the received data.

### Modified Example

The above-described embodiments are merely illustrative, and the present disclosure can be implemented by appropriately changing without departing from the spirit of the present disclosure.

For example, the processes and means described in the present disclosure may be freely combined to the extent that no technical conflict exists.

Also, the processing described as processing performed by a single apparatus may be shared and performed by a plurality of apparatuses. Alternatively, the processing described as processing performed by different apparatuses may be performed by a single apparatus. In a computer system, what hardware configuration (server configuration) to be employed to provide the respective functions can flexibly be changed.

The present disclosure can also be implemented by supplying computer programs implementing the functions described in the above embodiments to a computer and causing one or more processors included in the computer to read and execute the programs. Such computer programs may be provided to the computer via a non-transitory computer-readable memory medium that is connectable to a system bus of the computer or may be provided to the computer through the network. Examples of the non-transitory computer-readable memory medium include arbitrary types of disks including magnetic disks (e.g., a floppy (registered trademark) disk and a hard disk drive (HDD)) and optical disks (e.g., a CD-ROM, a DVD disk and a Blu-ray disk), a read-only memory (ROM), a random access memory (RAM), an EPROM, an EEPROM, a magnetic card, a flash memory, an optical card, and an arbitrary type of medium suitable for storing an electronic instruction.

What is claimed is:

1. An information processing apparatus comprising a controller including at least one processor configured to execute:
acquiring location information and a current status for each of a plurality of cooperators capable of performing rescue of a person to be rescued; and
transmitting a rescue request to a cooperator who is located within a predetermined range from the person to be rescued and is in a predetermined status, among the plurality of cooperators, as a target cooperator, when a person to be rescued is present.

2. The information processing apparatus according to claim 1, wherein
the controller is configured to:
receive first data including at least the location information from a mobile terminal held by each of the plurality of cooperators, the first data relating to the current status of each cooperator; and
estimate a status of each cooperator based on the first data.

3. The information processing apparatus according to claim 2, further comprising
a storage configured to store a typical behavioral pattern for each of the plurality of cooperators,
wherein the controller is configured to estimate the status of each cooperator by checking the location information included in the first data against the behavioral pattern.

4. The information processing apparatus according to claim 3, wherein the behavioral pattern is data in which a geographic location, the status, and a time frame are associated with one another.

5. The information processing apparatus according to claim 1, wherein
the controller is configured to:
further acquire current moving body for each of the plurality of cooperators; and
estimate required time until the target cooperator arrives at a location of the person to be rescued, based on the moving body.

6. The information processing apparatus according to claim 5, wherein the controller is configured to determine a cooperator to whom the rescue request is to be transmitted, based on the estimated required time.

7. The information processing apparatus according to claim 6, wherein the controller is configured to transmit the rescue request preferentially to a cooperator who has a shorter estimated required time than other cooperators.

8. The information processing apparatus according to claim 5, wherein
the moving body is a vehicle, and the controller is configured to:
acquire vehicle information from a vehicle associated with each of the plurality of cooperators; and
determine whether the target cooperator is riding in the vehicle, based on the vehicle information.

9. The information processing apparatus according to claim 5, wherein when a cooperator is not using a vehicle for movement, the controller is configured to calculate the required time in a case where the cooperator is caused to get on an autonomous traveling vehicle to go to the location of the person to be rescued.

10. The information processing apparatus according to claim 9, wherein
the controller is configured to:
acquire location information on a plurality of autonomous traveling vehicles; and
determine an allocable autonomous traveling vehicle based on the location information.

11. The information processing apparatus according to claim 1, further comprising
a storage configured to store data for each of the plurality of cooperators, in which the status of the cooperator is associated with whether the cooperator is capable of responding to the person to be rescued,
wherein the controller is configured to transmit the rescue request to the cooperator determined to be capable of responding to the rescue request based on the acquired status.

12. An information processing method comprising:
acquiring location information and a current status for each of a plurality of cooperators capable of performing rescue of a person to be rescued; and
transmitting a rescue request to a cooperator who is located within a predetermined range from the person to be rescued and is in a predetermined status, among the plurality of cooperators, as a target cooperator, when a person to be rescued is present.

13. A non-transitory memory medium storing a program, the program causing a computer to implement the information processing method according to claim 12.

14. An information processing system, comprising:
a plurality of mobile terminals that is respectively held by a plurality of cooperators capable of performing rescue of a person to be rescued; and
an information processing apparatus capable of communicating with the mobile terminals,
wherein the mobile terminal comprises a first controller including at least one processor configured to transmit, to the information processing apparatus, first data including at least location information, the first data relating to a current status of each cooperator, and
the information processing apparatus comprises a second controller including at least one processor configured to execute:
receiving the first data from the mobile terminals;
acquiring the location information and the current status for each of the plurality of cooperators, based on the first data; and
transmitting a rescue request to a cooperator who is located within a predetermined range from the person to be rescued and is in a predetermined status, among the plurality of cooperators, as a target cooperator, when a person to be rescued is present.

15. The information processing system according to claim 14, wherein the second controller is configured to estimate a status of each cooperator based on the first data acquired from the plurality of mobile terminals.

16. The information processing system according to claim 15, further comprising
a storage configured to store a typical behavioral pattern for each of the plurality of cooperators,
wherein the second controller is configured to estimate the status of each cooperator by checking the location information included in the first data against the behavioral pattern.

17. The information processing system according to claim 16, wherein the behavioral pattern is data in which a geographic location, the status, and a time frame are associated with one another.

18. The information processing system according to claim 14, wherein
the second controller is configured to:
further acquire current moving body for each of the plurality of cooperators; and
estimate required time until the target cooperator arrives at a location of the person to be rescued, based on the moving body.

19. The information processing system according to claim 18, wherein the second controller is configured to determine a cooperator to whom the rescue request is to be transmitted, based on the estimated required time.

20. The information processing system according to claim 14, further comprising
a storage configured to store data for each of the plurality of cooperators, in which the status of the cooperator is associated with whether the cooperator is capable of responding to the person to be rescued,
wherein the second controller is configured to transmit the rescue request to the cooperator determined to be capable of responding to the rescue request based on the acquired status.
